(19) United States
(12) Patent Application Publication
(10) Pub. No.: US 2005/0043436 A1
(43) Pub. Date: Feb. 24, 2005

(54) High gloss inks and preparations thereof

(76) Inventors: Wing Sum Vincent Kwan, Chicago, IL (US); Jennifer Carra, Bolingbrook, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/844,124

(22) Filed: May 12, 2004

Related U.S. Application Data
(60) Provisional application No. 60/496,299, filed on Aug. 19, 2003.

(51) Int. Cl. C03C 17/00; C09D 11/00

(52) U.S. Cl. 523/160; 523/161

(57) ABSTRACT

An improved high gloss ink for use in children's writing instruments is described. The improved high gloss ink avoids the use of metal-containing pigments and their relatively high costs. Further, the inks disclosed herein are affective in imparting a shiny or glossy appearance when dried on a porous or thin paper substrate, such as those commonly used for children's art materials, such as construction paper and paper used to fabricate children's coloring books. Thus, the inks disclosed herein not only provide a shiny or glossy appearance when dried, but also avoid bleed-through problems when used on thin paper substrates.

### CROSS-REFERENCE TO RELATED APPLICATION

This application claims the benefit under 35 U.S.C. § 119(e) of U.S. Provisional Patent Application Ser. No. 60/496,299, filed Aug. 19, 2003, the disclosure of which is incorporated herein by reference.

### BACKGROUND

1. Technical Field

Improved high gloss inks are disclosed. More specifically, improved high gloss inks that provide a high gloss or shiny coating on permeable substrates such as construction paper and paper used for coloring books are disclosed.

2. Background of the Related Art

Writing instruments have been pivotal in developing writing skills in children as well as developing their creativity. The success of any writing instrument designed for children depends very much on the amount of time spent by children using these instruments. To prolong this time of use, ink formulators have tried to incorporate special effects in the inks so as to attract the attention children and foster their creativity and imagination. These special effects commonly include bright colors, fluorescent colors, metallic colors, glittery colors, and inks that change color.

Of these special effects, shiny or glossy inks are the most common. These glossy or shiny inks usually include metallic pigments that contain metal particles or flakes. Some examples inks with metal pigments can be found in JP 10245517, JP 10330671, JP 11193362 and JP 01040263. As these inks dry, metal particles or flakes in the pigments remain on the upper surface of the paper thereby providing a shiny or mirror-like surface.

However, metallic pigments are usually more expensive than other pigments. The addition of such pigments into any ink formulation may render the ink too expensive to be used in a children's product, where cost is a predominate factor in the consumer's (i.e. the parent's) purchasing decision.

Conversely, despite the expense, metallic pigments are preferred for imparting a high gloss or shiny appearance to an ink because of the ability of metal flakes and particles to remain and collect on top of a paper substrate. In other words, metal flakes and particles tend not to be absorbed, even when the paper is relatively porous. Children's art paper, such as construction paper and coloring book paper, tends to be very porous resulting in a high degree of absorption and bleeding.

Hence, there exists a need to develop a high gloss ink without the use of expensive metal-containing pigments and which are effective when used on inexpensive, thin and porous paper commonly used for children's art supplies.

### SUMMARY OF THE DISCLOSURE

An alternative means for imparting a shiny appearance or a glossy appearance to children's ink formulations is provided. Specifically, use of a glossy resin is employed that will not penetrate into the paper fiber. As the ink that includes the resin is deposited on top of the paper, a layer of resin is formed relatively free of interruption by paper fiber upon drying and, a relatively continuous, pinhole-free or crater-free resin film is formed. In this way, the original gloss of the resin is retained, thereby imparting a glossy or shiny appearance to the dried ink.

Though dyes can be used in this application, it is more beneficial to use a pigment as the colorant. Being a dispersed and not dissolved entity, a pigment is more likely to remain with the resin on the surface of the paper without being absorbed into paper. This resistance to absorption is enhanced if the pigment has a relatively large average particle size.

Another benefit of using the disclosed inks is that the disclosed inks are resistant to bleeding. In other words, images written on one side of a piece of paper will tend not bleed through the thickness of the paper to the other side. This is very important for children as they use markers to color coloring books which are commonly made up of relatively thin and porous paper. Using the disclosed inks, children can color pictures on both sides of a coloring book page without much distortion of the pictures due to bleeding of the pigments through or across the page.

### DETAILED DESCRIPTION OF THE PRESENTLY PREFERRED EMBODIMENTS

The disclosed inks contain a colorant and a resin.

As mentioned above, the disclosed resins should have the ability to remain on top of a paper matrix or substrate as opposed to being absorbed. A resin can achieve this by being (1) a film-forming resin, (2) a large particle size or large average molecular weight massive or (3) being very hydrophobic or any combination of theses three related properties.

The first critical aspect is the resin's ability to form a film. Being a film-former refers to its ability to coalesce when laid down over a paper substrate, which, in the case of a coloring book or construction paper, may be relatively porous. To achieve a film-forming state, it is also advantageous for the components of the resin to have high molecular weights.

High molecular weight resins are known to be less penetrating. The overall lengthening in chain size and the consequent inter-chain entanglement are possible explanations for this less-penetrating behavior. In general, resins with molecular weights higher than 1000 can be used. More preferably, resins that have molecular weights in excess of 10,000 are used. Examples of such resins include, but are not limited to, VANCRYL 965 (Air Product, Allentown, Pa.) and JONCRYL 98 (S.C. Johnson & Sons, Racine, Wis.).

Apart from molecular weight, increasing the hydrophobic component of one or more polymers in the resin will also render a resin less penetrating. Increasing the hydrophobic component of polar resins will decrease the penetration of the resin into a paper substrate. One common resin is a chemical hybrid of styrene and acrylic acid. Incorporation of styrene monomer into a water-soluble acrylic backbone will increase its hydrophobicity as well its hardness, both of which will allow the resin to coalesce and remain on top of a paper substrate. An example of such behavior can be found in NEORESIN A-1093 (NY). The mole ratio of styrene and acrylic monomers can range from about 20:1 to about 1:20.

Besides organic resins, inorganic resins can also be used. Applicable inorganic resins are those which can exist as a water solution or solid dissolvable in water but becomes water-insoluble upon drying. One example of such a resin is a silicate of a metal salt. PQ Corporation (PA) supplies silicates of various metal salts under the trade name of KASIL (potassium silicate) and SILICATE E.

To further enhance the “buoyancy” of the resin or the ability of the resin to coalesce and form a film on the surface of the paper, pigments are preferred as colorants. This is even so when the ink is written on a very porous substrate. As pigments are particles and not dissolved species, they can be used to form an infra-structure for the resin to float on porous substrate. In essence, any pigments that do not react or dissolve in the dispersed medium can be used. The pigment can be organic or inorganic.

Suitable blue pigments include, but are not limited to, PALOMAR BLUE B-4810 PB 15:3, PALOMAR BLUE B-4710 PB 15:1, and PALOMAR BLUE B-4900 pigments (all available from Bayer Corp.); and SUNFAST BLUE 15:3 presscake and SUNFAST BLUE 15:3 powder (available from Sun Chemical Corp.).

Suitable red pigments include, but are not limited to, magenta pigments like QUINDO MAGENTA RV-6828 Pigment Red 122, QUINDO MAGENTA RV-6831 Pigment Red 122 presscake, QUINDO RED R-6713 PV 19, and QUINDO MAGENTA RV-6843 Pigment Red 202 pigments (all available from Bayer Corp.); and SUNFAST MAGENTA 122 and SUNFAST MAGENTA 202 pigments (both available from Sun Chemical Corp.).

Suitable yellow pigments include, but are not limited to, FANCHON FAST Y-5700 PY 139 and FANCHON FAST Yellow Y-5688 C.I. Pigment Yellow 150 pigments (available from Bayer Corp. of Rock Hill, S.C.); SUNBRITE YELLOW 14 presscake and SPECTRA PAC YELLOW 83 pigments (both available from Sun Chemical Corp. of Cincinnati, Ohio); SANDORIN YELLOW 6GL (available from Clariant Corp. of Charlotte, N.C.); and IRGAZIN YELLOW 2RLT PY 110, IRGAZIN YELLOW 2GLTN PY 109, IRGAZIN YELLOW 2GLTE PY 109, and IRGAZIN YELLOW 3RLTN PY 110 pigments (all available from Ciba Geigy).

Suitable green pigments include, but are not limited to, copper phthalocyanine green pigment like PIGMENT GREEN 1, PIGMENT GREEN 2, PIGMENT GREEN 7, and PIGMENT GREEN 36, and mixtures thereof. These pigments are available from Organic Pigment Corp. of Greensboro, N.C. and other sources known to those skilled in the art.

Violet colorants typically comprise a quinacridone or a benzimidazolone pigment. Violet colorants useful include PIGMENT VIOLET 19, PIGMENT VIOLET 3, PIGMENT VIOLET 32, and PIGMENT VIOLET 23, and mixtures thereof. These pigments are available from Organic Pigment Corp. of Greensboro, N.C. and other sources known to those skilled in the art.

Orange colorants typically comprise a beta-naphthol pigment or a naphthol red pigment. Orange colorants useful in the invention include PIGMENT ORANGE 5, PIGMENT RED 17, PIGMENT RED 188, PIGMENT ORANGE 62, PIGMENT RED 112, PIGMENT RED 255, PIGMENT RED 264, and PIGMENT RED 49:2, and mixtures thereof. These pigments are available from Organic Pigment Corp. of Greensboro, N.C. and other sources known to those skilled in the art.

The color may also include black pigments like carbon black, such as SPECIAL BLACK 4, SPECIAL BLACK 5, SPECIAL BLACK 6, SPECIAL BLACK 4A, COLOR BLACK FW 200, and COLOR BLACK FW2 pigments (all manufactured by Degussa Corporation of Ridgefield, N.J.); RAVEN 1200 carbon black, RAVEN 1170 carbon black, RAVEN 3500 carbon black, and RAVEN 5750 carbon black pigments (all available from Columbian Chemical Corp. of Atlanta, Ga.); MOGUL L carbon black and STERLING NS carbon black pigments (both available from Cabot Corp. of Boston, Mass.); and CARBON BLACK MA-100 pigment (available from Mitsubishi Kasei Corp. of Tokyo, Japan).

However, as the ability for the pigment to remain as a coating or film on top of the paper depends on the ultimate particle size, pigments with a larger particle size is more preferred. The pigment is preferred to have a mean pigment size of at least 0.1 microns, and more preferably at least 0.5 micron, and even more preferably at least 1 micron. Although dry pigments are usually available, for practical purposes and ease of ink preparation, other forms of commercial available pigment pre-dispersed forms are utilized. Representative commercial pigments that can be used in the form of a water wet presscake include: HEUCOPHTHAL Blue BT-585-P, TOLUIDINE red Y (C.I. Pigment Red 3), QUINDO Magenta (Pigment Red 122), Magenta RV-6831 presscake (Mobay Chemical, Harmon Division, Haledon, N.J.), SUNFAST. Magenta 122 (Sun Chemical Corp., Cincinnati, Ohio), INDO BRILLIANT SCARLET (Pigment Red 123, C.I. No. 71145), TOLUIDINE Red B (C.I. Pigment Red 3), WATCHUNG Red B (C.I. Pigment Red 48), PERMANENT RUBINE F6B13-1731 (Pigment Red 184), HANSA Yellow (Pigment Yellow 98), DALAMAR Yellow YT-839-P (Pigment Yellow 74, C.I. No. 11741, SUNBRITE Yellow 17 (Sun Chemical Corp, Cincinnati, Ohio), TOLUIDINE Yellow G (C.I. Pigment Yellow 1), PIGMENT Scarlet (C.I. Pigment Red 60), AURIC Brown (C.I. Pigment Brown 6), etc.

Black pigments, such as carbon black, are generally not available in the form of aqueous presscakes. Another form of applicable pre-dispersed pigment can be pigment dispersion in solvents. For water-based inks, pigment dispersion in water is commonly used. Examples of these dispersions include the ORASPERSE and ORAPAD series supplied by Organic Pigment Corporation (Greensboro, S.C.), the HOSTAFINE series supplied by Clariant (Coventry, R.I.), the UNISPERSE series from Ciba (S.C.), and the LUCONYL series from BASF (Mt. Olive, N.J.).

Other optional additives that are known in the art may be added to the formulation of the ink to enhance its properties or processability. These additives include, but are not limited to, surfactants, defoamers, anti-microbial agents, viscosity modifiers, anti-skinning agents, dispersing agents, pH buffers and so on.

The following examples may help to illustrate the preparation of the disclosed inks. It is understood that these examples are given just of illustration purpose and should not be used to limit the scope and spirit of the disclosure.

### EXAMPLE 1

### Red Glossy Ink

To a well-agitated mixture of 39 parts of NEORESIN BT-44, 27 parts of NEORESIN A 1093 (both from NeoResin, Wilmington, Mass.), 27 parts of deionized water and 0.4 parts of SURFYNOL 440 (Air Products, Allentown, Pa.) was added 6.6 parts of ORASPERSE NAPHTHOL Red 2 (Organic Pigment Corporation, Greensboro, S.C.). The mixing was continued for another thirty minutes. 2.0 cc of ink was withdrawn and put into a marker. A color swatch was produced using this glossy ink. Upon drying, the gloss of the color swatch was examined by a gloss meter (BYK) and the result was compared to that of a marker using regular water-based ink of the same color.

### EXAMPLE 2

### Black Glossy Ink

To a well-agitated mixture of 39 parts of NEORESIN BT-44, 27 parts of NEORESIN A 1093 (both from NeoResin, Wilmington, Mass.), 27 parts of deionized water and 0.4 parts of SURFYNOL 440 (Air Products, Allentown, Pa.) was added 6.6 parts of ECONOJET 101, (Wolstenholme International, West Chicago, Ill.). The mixing was continued for another thirty minutes. 2.0 cc of ink was withdrawn and put into a marker. A color swatch was produced using this glossy ink. Upon drying, the gloss of the color swatch was examined by a gloss meter (BYK) and the result was compared to that of a marker using regular water-based ink of the same color.

### EXAMPLE 3

### Blue Glossy Ink

To a well-agitated mixture of 39 parts of NEORESIN BT-44, 27 parts of NEORESIN A 1093 (both from NeoResin, Wilmington, Mass.), 27 parts of deionized water and 0.4 parts of SURFYNOL 440 (Air Products, Allentown, Pa.) was added 6.6 parts of ORASPERSE BLUE 3GG4317 (Organic Pigment Corporation, Greensboro, S.C.). The mixing was continued for another thirty minutes. 2.0 cc of ink was withdrawn and put into a marker. A color swatch was produced using this glossy ink. Upon drying, the gloss of the color swatch was examined by a gloss meter (BYK) and the result was compared to that of a marker using regular water-based ink of the same color.

### EXAMPLE 4

### Purple Glossy Ink

To a well-agitated mixture of 39 parts of NEORESIN BT-44, 27 parts of NEORESIN A 1093 (both from NeoResin, Wilmington, Mass.), 27 parts of deionized water and 0.4 parts of SURFYNOL 440 (Air Products, Allentown, Pa.) was added 6.6 parts of ORASPERSE Violet C-5119 (Organic Pigment Corporation, Greensboro, S.C.). The mixing was continued for another thirty minutes. 2.0 cc of ink was withdrawn and put into a marker. A color swatch was produced using this glossy ink. Upon drying, the gloss of the color swatch was examined by a gloss meter (BYK) and the result was compared to that of a marker using regular water-based ink of the same color.

TABLE 1
Comparison of gloss of the coating formed by regular water-
based inks (from three manufacturers) and disclosed inks.

| | | Sanford | Marker B | | | Average |
|---|---|---|---|---|---|---|
| Exam- | | “Colorific | “Crayola | Marker C | Disclosed | Enhancement |
| ple | Color | Classic” | Classic” | “Colorgear” | Inks | (%) (Note 1) |
| 1 | Red | 1.9 | 1.7 | 1.9 | 10.2 | 556 |
| | | | | | (Example 1) | |
| 2 | Black | 1.4 | 1.7 | 1.4 | 10.8 | 720 |
| | | | | | (Example 2) | |
| 3 | Blue | 1.3 | 1.5 | 1.5 | 10.8 | 754 |
| | | | | | (Example 3) | |
| 4 | Purple | 1.6 | 1.7 | 1.9 | 9.9 | 571 |
| | | | | | (Example 4) | |

Note 1. Enhancement (%) is calculated by dividing the gloss of the disclosed ink coatings by an average gloss reading of the three known ink coatings of regular water-based markers (i.e., the Sanford Colorific Classic and the two off-the-shelf markers).

As shown by the data in Table 1, color swatches produced by the inks of Examples 1-4 exhibit five to seven times more gloss than the corresponding regular water-based inks of like color.

These inks that provide high gloss and non-bleed behavior on porous paper are disclosed which allow children to color both sides of the coloring book without much difficulty. These disclosed inks achieve the high gloss effect without resorting to costly metallic pigments. Appreciable amounts of metallic pigments need not be used to achieve the gloss meter readings cited above.

While only certain embodiments have been set forth and described, alternative embodiments and various modifications will be apparent from the above description to those skilled in the art. These and other alternatives are considered equivalents and within the spirit and scope of this disclosure.

1. A high gloss ink comprising:
a resin,
a colorant,
wherein the ink does not include appreciable amounts of metallic pigments.

2. The high gloss ink of claim 1 wherein the resin has a molecular weight of greater than 1000.

3. The high gloss ink of claim 1 wherein the resin has a molecular weight of greater than 10,000.

4. The high gloss ink of claim 1 wherein the resin is hydrophobic.

5. The high gloss ink of claim 1 wherein the resin comprises a polymer comprising styrene and acrylic acid monomer units.

6. The high gloss ink of claim 5 wherein a ratio of styrene to acrylic acid ranges from about 20:1 to about 1:20.

7. The high gloss ink of claim 1 wherein the resin comprises a silicate and a metal salt.

8. The high gloss ink of claim 1 wherein the pigment has a mean particle size of greater than or equal to 0.1 μm.

9. The high gloss ink of claim 1 wherein the pigment has a mean particle size of greater than or equal to 1.0 μm.

10. The high gloss ink of claim 1 further comprising water.

11. The high gloss ink of claim 1 wherein the pigment is selected from the group consisting of:
PALOMAR BLUE B-4810 PB 15:3; PALOMAR BLUE B-4710 PB 15:1; PALOMAR BLUE B-4900; SUNFAST BLUE 15:3; SUNFAST BLUE 15:3; QUINDO MAGENTA RV-6828 Red 122; QUINDO MAGENTA RV-6831 Red 122; QUINDO RED R-6713 PV 19 Red 202; QUINDO MAGENTA RV-6843 Red 202; SUNFAST MAGENTA 122 Red 202; SUNFAST MAGENTA Red 202; FANCHON FAST Y-5700 PY 139 Yellow 150; FANCHON FAST Yellow Y-5688 C.I. Pigment Yellow 150; SUNBRITE YELLOW 14; SPECTRA PAC YELLOW 83; SANDORIN YELLOW 6GL; IRGAZIN YELLOW 2RLT PY 110; IRGAZIN YELLOW 2GLTN PY 109; IRGAZIN YELLOW 2GLTE PY 109; IRGAZIN YELLOW 3RLTN PY 110; PIGMENT GREEN 1; PIGMENT GREEN 2; PIGMENT GREEN 7; PIGMENT GREEN 36; PIGMENT VIOLET 19; PIGMENT VIOLET 3; PIGMENT VIOLET 32; PIGMENT VIOLET 23; PIGMENT ORANGE 5; PIGMENT RED 17; PIGMENT RED 188; PIGMENT ORANGE 62; PIGMENT RED 112; PIGMENT RED 255; PIGMENT RED 264; PIGMENT RED 49:2; SPECIAL BLACK 4; SPECIAL BLACK 5; SPECIAL BLACK 6; SPECIAL BLACK 4A; COLOR BLACK FW 200; COLOR BLACK FW2; RAVEN 1200 carbon black; RAVEN 1170 carbon black; RAVEN 3500 carbon black; RAVEN 5750 carbon black; MOGUL L carbon black; STERLING NS carbon black; CARBON BLACK MA-100; HEUCOPHTHAL Blue BT-585-P; TOLUIDINE red Y (C.I. Pigment Red 3); QUINDO Magenta (Pigment Red 122); Magenta RV-6831; SUNFAST. Magenta 122; INDO BRILLIANT SCARLET (Pigment Red 123, C.I. No. 71145); TOLUIDINE Red B (C.I. Pigment Red 3); WATCHUNG Red B (C.I. Pigment Red 48); PERMANENT RUBINE F6B13-1731 (Pigment Red 184); HANSA Yellow (Pigment Yellow 98); DALAMAR Yellow YT-839-P (Pigment Yellow 74, C.I. No. 11741; SUNBRITE Yellow 17; TOLUIDINE Yellow G (C.I. Pigment Yellow 1); PIGMENT Scarlet (C.I. Pigment Red 60); AURIC Brown (C.I. Pigment Brown 6); and mixtures thereof.

12. The high gloss ink of claim 1 wherein the pigment is selected from the group consisting of:
copper phthalocyanine green pigments; quinacridone pigments; benzimidazolone pigments; beta-naphthol pigments; naphthol red pigments; carbon black; and mixtures thereof.

13. A high gloss ink comprising:
a resin,
a colorant,
water, and
wherein the ink is free of metallic pigments.

14. The high gloss ink of claim 13 wherein the resin has a molecular weight of greater than 1000.

15. The high gloss ink of claim 13 wherein the resin has a molecular weight of greater than 10,000.

16. The high gloss ink of claim 15 wherein the resin is hydrophobic.

17. The high gloss ink of claim 15 wherein the resin comprises a polymer comprising styrene and acrylic acid monomer units.

18. The high gloss ink of claim 15 wherein a ratio of styrene to acrylic acid ranges from about 20:1 to about 1:20.

19. The high gloss ink of claim 13 wherein the resin comprises a silicate and a metal salt.

20. The high gloss ink of claim 13 wherein the pigment has a mean particle size of greater than or equal to 0.1 μm.

21. The high gloss ink of claim 15 wherein the pigment has a mean particle size of greater than or equal to 1.0 μm.

22. The high gloss ink of claim 13 wherein the pigment is selected from the group consisting of:
PALOMAR BLUE B-4810 PB 15:3; PALOMAR BLUE B-4710 PB 15:1; PALOMAR BLUE B-4900; SUNFAST BLUE 15:3; SUNFAST BLUE 15:3; QUINDO MAGENTA RV-6828 Red 122; QUINDO MAGENTA RV-6831 Red 122; QUINDO RED R-6713 PV 19 Red 202; QUINDO MAGENTA RV-6843 Red 202; SUNFAST MAGENTA 122 Red 202; SUNFAST MAGENTA Red 202; FANCHON FAST Y-5700 PY 139 Yellow 150; FANCHON FAST Yellow Y-5688 C.I. Pigment Yellow 150; SUNBRITE YELLOW 14; SPECTRA PAC YELLOW 83; SANDORIN YELLOW 6GL; IRGAZIN YELLOW 2RLT PY 110; IRGAZIN YELLOW 2GLTN PY 109; IRGAZIN YELLOW 2GLTE PY 109; IRGAZIN YELLOW 3RLTN PY 110; PIGMENT GREEN 1; PIGMENT GREEN 2; PIGMENT GREEN 7; PIGMENT GREEN 36; PIGMENT VIOLET 19; PIGMENT VIOLET 3; PIGMENT VIOLET 32; PIGMENT VIOLET 23; PIGMENT ORANGE 5; PIGMENT RED 17; PIGMENT RED 188; PIGMENT ORANGE 62; PIGMENT RED 112; PIGMENT RED 255; PIGMENT RED 264; PIGMENT RED 49:2; SPECIAL BLACK 4; SPECIAL BLACK 5; SPECIAL BLACK 6; SPECIAL BLACK 4A; COLOR BLACK FW 200; COLOR BLACK FW2; RAVEN 1200 carbon black; RAVEN 1170 carbon black; RAVEN 3500 carbon black; RAVEN 5750 carbon black; MOGUL L carbon black; STERLING NS carbon black; CARBON BLACK MA-100; HEUCOPHTHAL Blue BT-585-P; TOLUIDINE red Y (C.I. Pigment Red 3); QUINDO Magenta (Pigment Red 122); Magenta RV-6831; SUNFAST. Magenta 122; INDO BRILLIANT SCARLET (Pigment Red 123, C.I. No. 71145); TOLUIDINE Red B (C.I. Pigment Red 3); WATCHUNG Red B (C.I. Pigment Red 48); PERMANENT RUBINE F6B13-1731 (Pigment Red 184); HANSA Yellow (Pigment Yellow 98); DALAMAR Yellow YT-839-P (Pigment Yellow 74, C.I. No. 11741; SUNBRITE Yellow 17; TOLUIDINE Yellow G (C.I. Pigment Yellow 1); PIGMENT Scarlet (C.I. Pigment Red 60); AURIC Brown (C.I. Pigment Brown 6); and mixtures thereof.

23. The high gloss ink of claim 13 wherein the pigment is selected from the group consisting of:
copper phthalocyanine green pigments; quinacridone pigments; benzimidazolone pigments; beta-naphthol pigments; naphthol red pigments; carbon black; and mixtures thereof.

24. A high gloss ink comprising:
a hydrophobic resin having an average molecular weight of greater than 10,000,
a colorant,
water, and
wherein the ink is free of metallic pigments.
